(19) United States
(12) Patent Application Publication
(10) Pub. No.: US 2004/0021950 A1
(43) Pub. Date: Feb. 5, 2004

(54) Holographic rangefinder sunglasses

(76) Inventor: Dan Arnold Norton, Manheim, PA (US)

Correspondence Address: William H. Eilberg, 420 Old York Road, Jenkintown, PA, 19046, US

(21) Appl. No.: 10/387,277

(22) Filed: Mar. 12, 2003

Related U.S. Application Data
(60) Provisional application No. 60/401,189, filed on Aug. 5, 2002.

(51) Int. Cl. G02C 5/00; G02B 27/14

(52) U.S. Cl. 359/631; 351/150

(57) ABSTRACT

A rangefinder is incorporated into a pair of eyeglasses or sunglasses. A pair of holographic images, one including a distance-measuring scale and the other including a pointer, are projected separately into the eyes of a user, such that the images become superimposed over the user's field of view. As the user focuses on a distant object, the user's eyes move, and such movement causes the apparent position of the pointer, relative to the scale, to change. When the user has focused on the object, the pointer indicates a value which represents the distance of the object. The rangefinder can be used by golfers, hunters, surveyors, or the like, to provide a hands-free method of measuring distance.

### CROSS-REFERENCE TO PRIOR PROVISIONAL APPLICATION

This application claims the priority of U.S. Provisional Application Serial No. 60/401,189, filed Aug. 5, 2002.

### BACKGROUND OF THE INVENTION

The present invention relates to the field of range-finding devices, and provides a pair of eyeglasses, especially sunglasses, that enable the wearer to determine quickly the distance to selected objects.

Various range-finding devices have been proposed in the prior art. It is known, for example, to provide an apparatus which generates a laser beam, or other beam of electromagnetic radiation, and which directs the beam to an object and measures the time taken by the beam to return to its starting point. This measurement of time is directly related to the distance of the object, and can be used to perform an immediate computation and display of distance.

Range-finding devices of the type described above have inherent disadvantages. First, such devices must be manually aimed and manually operated. This feature is a disadvantage when the rangefinder is used by a hunter who is already holding a rifle with both hands, or by a golfer who is holding a golf club with both hands, or by a participant in any other activity that requires the use of both hands. If only one person is available, the user must activate the rangefinder, set it down, and return to a previous position, hoping that the rangefinder is still properly aimed. In the prior art, the only way to insure reliable hands-free operation has been to provide a second person to operate the rangefinder.

Secondly, laser range-finding devices are not particularly accurate in rain or fog, and can also give false readings when used in environments in which there are excessive amounts of sunlight.

Thirdly, laser range-finding equipment is relatively expensive, and can be comparatively heavy and bulky.

The present invention provides a rangefinder that overcomes the above-described disadvantages. The present invention solves the above problems by providing a rangefinder device that is formed as part of a pair of eyeglasses or sunglasses, and which generates almost instantly an image that tells the wearer the distance to any selected object.

### SUMMARY OF THE INVENTION

In a preferred embodiment, the present invention comprises a pair of eyeglasses, especially sunglasses, that have been modified to include a rangefinder apparatus. The eyeglasses include a frame which holds first and second holographic films or slides, both films defining previously prepared images. The image on one film includes a distance-measurement scale, and the image on the other film includes a pointer. An optical arrangement includes a pair of sources of illumination, such as light-emitting diodes, which project the images recorded in the films separately into each eye of a user. When the user looks through the eyeglasses, and when the films are illuminated, the user sees, in addition to the normal field of view, the superposition of the two images.

As the user begins to focus his or her gaze on a particular distant object, the user's eyes move slightly, such that rays extending from the eyes converge on the object. A change in the position of the eyes changes the angle at which the user views the holographic slides, and even a slight change in this viewing angle causes a perceptible change in the projected holographic image. In particular, as the user's eyes converge on the object, the eyes move slightly, and the pointer is perceived to move relative to the scale. When the user has finished focusing on the distant object, the eyes stop moving, and the pointer comes to rest at some position along the scale, from which the distance of the object can be directly read. The user reads this distance without having to perform any manual operation. The rangefinder of the present invention in effect produces a “heads up” display which operates in a hands-free manner.

The optical components necessary to produce the images described above are carried by the frame of the eyeglasses. A switch, preferably also mounted to the frame, controls the state of the light-emitting diodes (LEDs). When the LEDs are turned off, the eyeglasses function as ordinary eyeglasses or sunglasses. When the LEDs are turned on, the user sees the heads-up display from which the range of various objects can be determined.

The present invention therefore has the primary object of providing a rangefinder device.

The invention has the further object of providing a rangefinder that can be formed as part of a pair of eyeglasses or sunglasses.

The invention has the further object of providing a rangefinder that can determine distances without any manual operations.

The invention has the further object of providing a hands-free rangefinder that is especially useful for persons engaged in outdoor activities such as golf, hunting, surveying, or other activities.

The invention has the further object of providing rangefinder eyeglasses wherein the range-finding function can be turned on or off.

The invention has the further object of providing a hands-free method of determining the distance of an object.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a schematic diagram of the optical arrangement used in the present invention.

FIG. 2 provides a diagram showing an image, produced by the present invention, and detected by eye of a user.

FIG. 3 provides a diagram showing an image, produced by the present invention, and detected by the other eye of the user.

FIG. 4 provides a diagram showing the superposition of the images of FIGS. 2 and 3, and represents a stereoscopic image perceived by the user of the present invention.

FIG. 5 provides a ray diagram illustrating the use of the present invention in identifying objects located at various distances from a user.

FIG. 6 provides a partially schematic top view of an eyeglass frame, showing the components of the rangefinder eyeglasses of the present invention.

FIG. 7 provides a diagram similar to FIG. 6, and showing the electrical connections used in the rangefinder eyeglasses of the present invention.

FIG. 8 provides a perspective view, taken from the right side, of a pair of rangefinder sunglasses made according to the present invention.

FIG. 9 provides a perspective view, taken from the front side, of a pair of rangefinder sunglasses made according to the present invention.

### DETAILED DESCRIPTION OF THE INVENTION

The present invention is a range-finding device which is preferably built into a pair of eyeglasses, especially sunglasses. In brief, the range-finding device uses a light source and a prerecorded holographic film to project two distinct images into the two eyes of the user. When wearing the eyeglasses, the user views the images in a binocular manner, and sees the two images superimposed on each other, in addition to the normal field of view. At least one of the two superimposed images comprises a scale, and the other image comprises a pointer. When the user focuses on an object, the user's eyes move naturally such that the apparent position of the pointer relative to the scale indicates a distance that can be read off by the user.

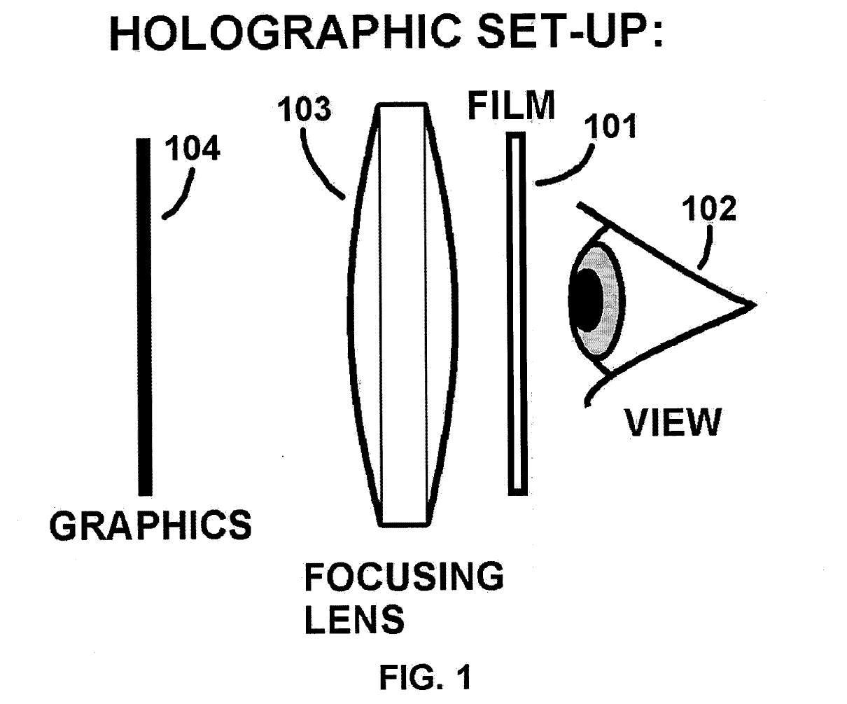

FIG. 1 provides a diagram showing a basic optical arrangement of the present invention, as applied to one eye. A holographic film 101 is disposed in front of an eye 102 of the user. A focusing lens 103 projects light passing through the film such that the user sees a virtual image represented by reference numeral 104. The image seen by the user is determined by the recorded content of the holographic film. The invention provides two such holographic images, one for each eye, the images being different from each other, and being viewed in superposition by the user, as described below.

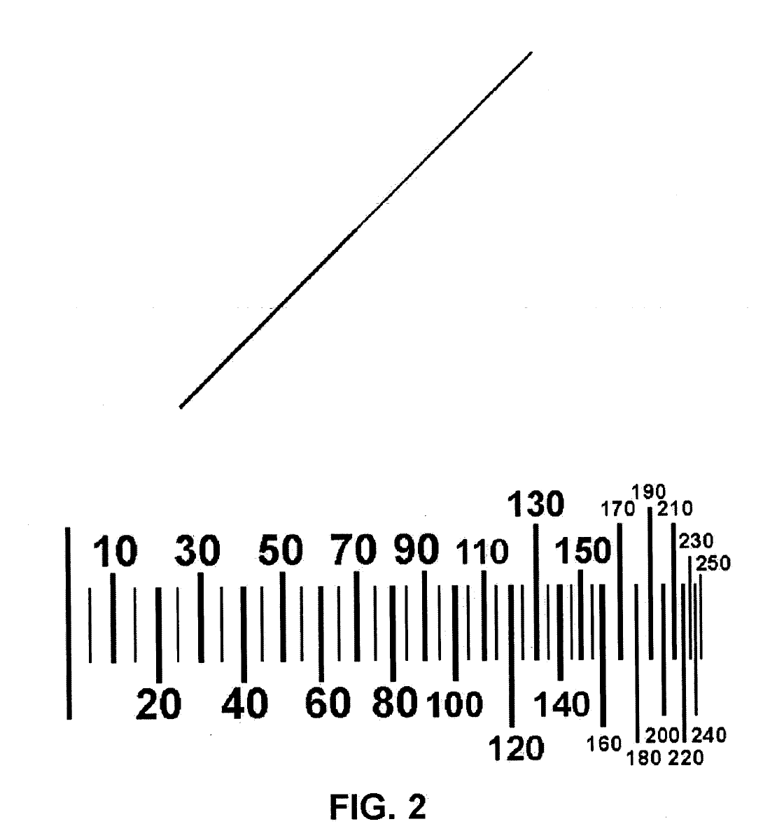

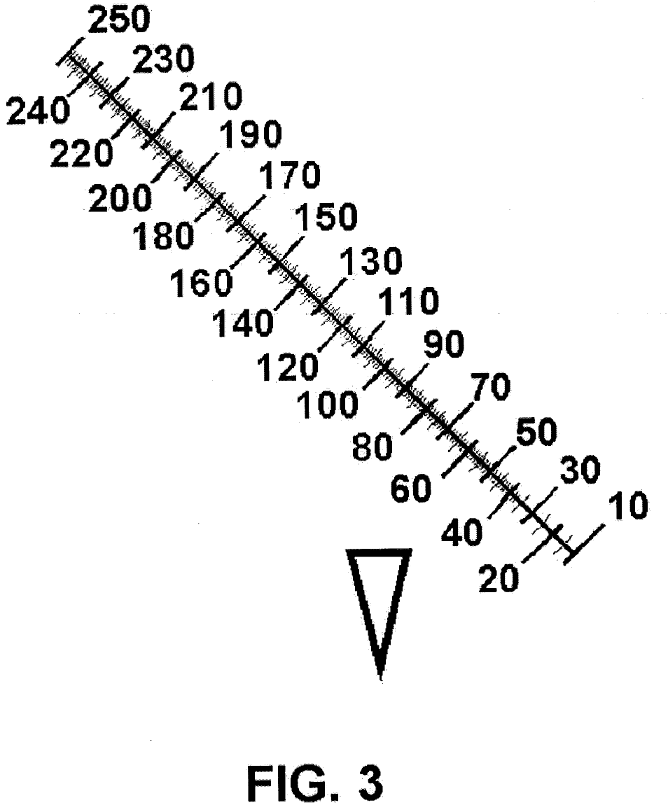

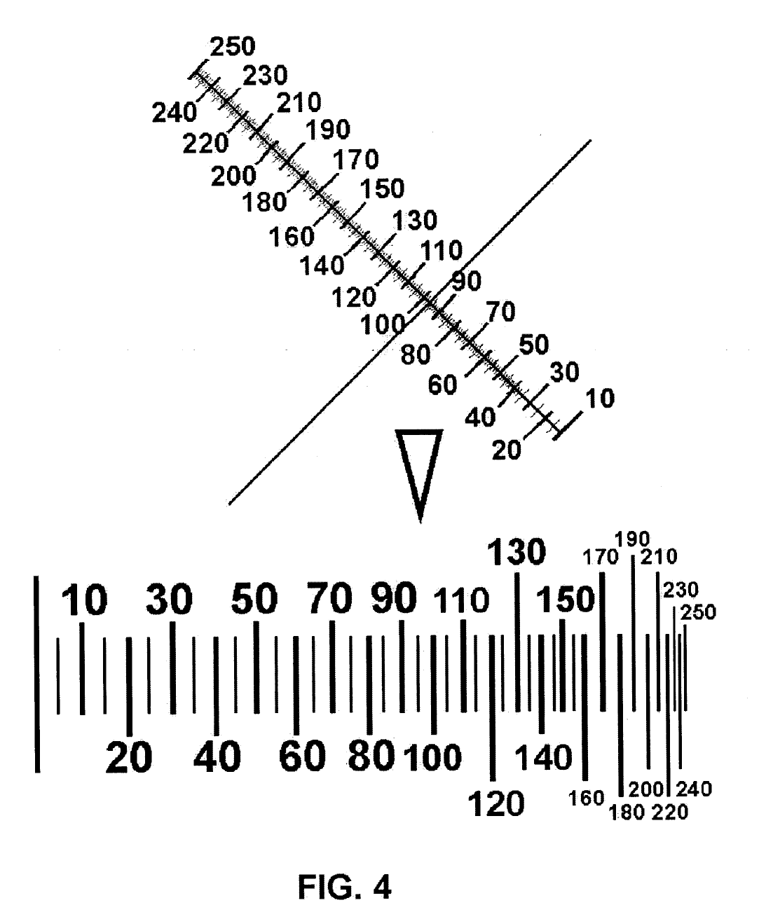

FIG. 2 provides an example of an image that could be projected onto, say, the user's left eye, and FIG. 3 represents an example of an image that would be projected onto the user's right eye, using an arrangement similar to that of FIG. 1. When these images are superimposed, the result is as shown in FIG. 4.

In the example given, the image represented in FIG. 2 includes a line, which serves as a pointer, and a horizontal scale which is calibrated to indicate distances. The image represented in FIG. 3 includes a diagonal scale calibrated to indicate distances, and a triangular pointer. In the superimposed image of FIG. 4, it is seen that the line from FIG. 2 becomes superimposed on the diagonal scale of FIG. 4, and the triangular pointer of FIG. 3 points to a value on the horizontal scale of FIG. 2.

In the above example, there are two scales in the superimposed image, and the distance can be read from either or both scales. In practice, it is not necessary to provide such redundancy. For example, the image projected into the left eye could include only a pointer, and the image projected into the right eye could include only a scale, or vice versa. All that is required is that when the two images are superimposed, the result is an image which includes at least one pointer and one scale, wherein the pointer comes from an image projected into one eye and the scale comes from an image projected into the other eye. The pointer thus identifies a value along the scale.

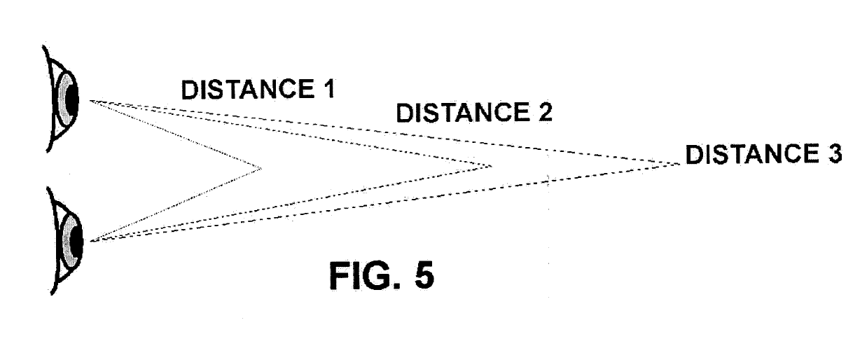

The movement of the pointer(s) relative to the scale(s) is a function of the natural movement of the user's eyes. FIG. 5 illustrates this principle. FIG. 5 shows the user's two eyes, and illustrates the positions of rays of light when the user observes objects at three different distances, labeled Distance 1, Distance 2, and Distance 3. For each object, the angle made by the rays of light, relative to a horizontal reference line, is different. Each such angle can be directly correlated with a distance, i.e. the distance at which the rays converge. To obtain convergence at each of the three indicated distances, the user's eyes must assume a slightly different position for each point. When the user moves his or her eyes from one position to another, the user changes the angle at which the holographic image is viewed, and the image changes as a result. Due to the nature of the holographic image, even very small eye movements result in significant movements of the perceived image. In theory, for each possible value of measured distance, there is a unique position of the eyes. Simply by focusing on a particular distant object, the user naturally moves his or her eyes into the position that causes the object to be focused, and in doing so, the user automatically perceives an image of a pointer and a scale which indicates distance.

It is therefore the natural movement of the user's eyes which causes the perceived pointer(s) to move relative to the scale(s), in the composite image seen by the user.

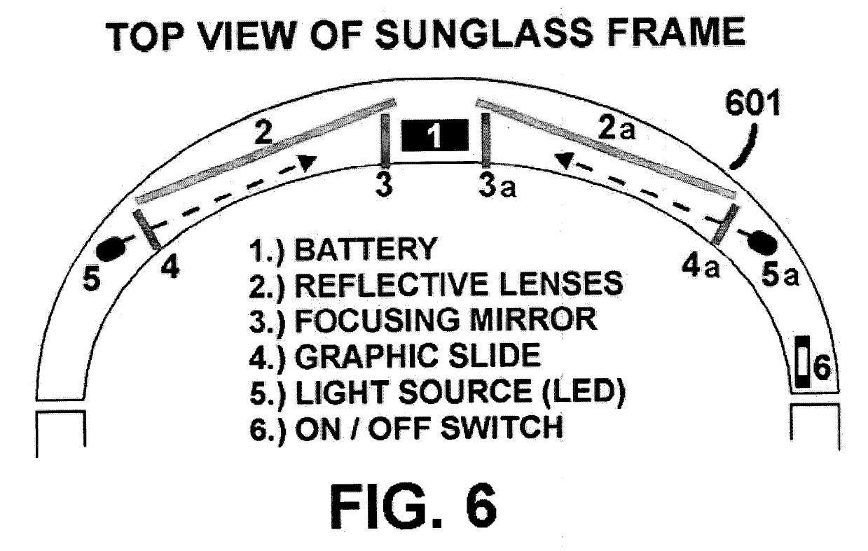

FIG. 6 provides a partially schematic top view of the frame of the eyeglasses made according to the present invention, and illustrating its essential components. Frame 601 is sufficiently thick, and hollow, so that it can house the components and hide them from view to the extent practical.

As shown in FIG. 6, the frame contains a battery 1, which powers the light sources 5 and 5a. Switch 6 opens or closes the connections between the light sources and the battery. When the switch is opened, and the light sources are off, the range-finding feature is deactivated, and the device functions as a pair of ordinary eyeglasses or sunglasses.

When switch 6 is closed, the light source 5, which is preferably a light-emitting diode (LED), produces a ray of light that passes through graphic slide 4. Slide 4 is a holographic film that has been previously prepared to contain an image similar to those depicted in FIGS. 2 or 3. Light passing through the slide 4 is reflected from mirror 3, which in turn directs the light to reflective lens 2. The reflective lens may be a thin film that is adjacent to the regular lens of the eyeglass. In the preferred embodiment, the reflective lens is an overlay that abuts the regular lens. The reflective lens 2 causes the light to be directed into the user's left eye, so that the user's left eye sees the image recorded on slide 4. Also, the lens 2 focuses the virtual image of the slide as perceived by the user.

The optical arrangement in the preferred embodiment of FIG. 6 differs from the simplified version of FIG. 1, in that the holographic film or slide 4 is not placed directly in front of the eye. Instead, the contents of the slide are projected by a lens and mirror combination. The result is the same in both cases. The lens 2 in the embodiment of FIG. 6 performs the same function as lens 103 of FIG. 1.

The formation of the image displayed to the right eye is the same as described with respect to the left eye. The reflective lens, the focusing mirror, the slide, and the LED, for the right eye, are designated by the reference numerals 2a, 3a, 4a, 5a, and 6a, respectively.

As will be appreciated from FIG. 6, when the LEDs are activated, the contents of the two slides 4 and 4a are projected into the left and right eyes, respectively, of the user. As long as both eyes are open, the user sees a superposition of the contents of these two slides, as well as whatever scenery is in the user's field of view. The optical arrangement of the present invention insures that the images formed by the slides do not distort the view of the environment seen by the user. The user simply sees an ordinary view, with the images from the slides superimposed.

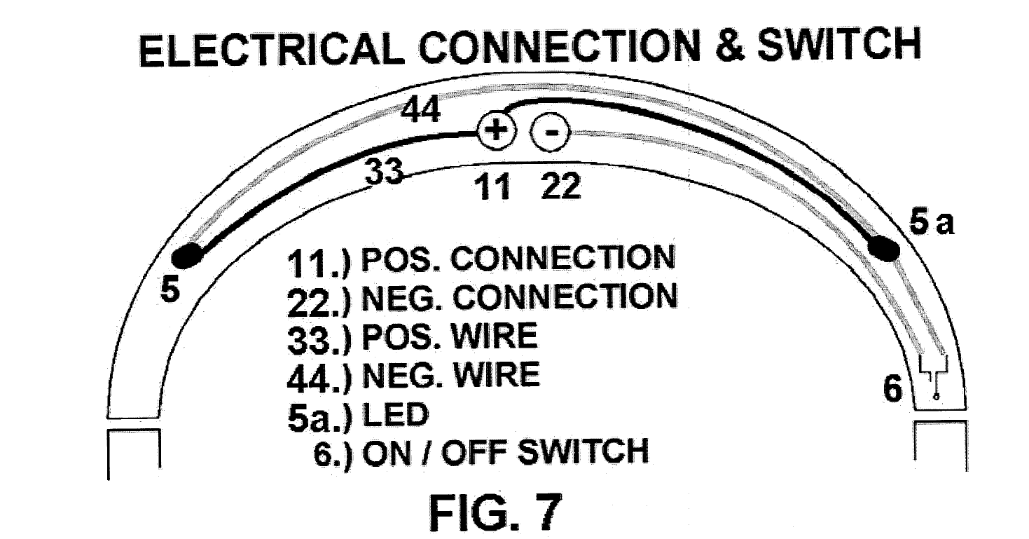

FIG. 7 provides details of the connections between the battery and the LEDs. The battery has a positive terminal 11 and a negative terminal 22. The positive terminal is connected to one lead from LED 5 and to one lead from LED 5a. The negative terminal 22 is connected to one contact of switch 6, the other contact of the switch being connected to complete the circuit. The LEDs 5 and 5a are therefore connected in series with the switch and the battery. Closing the switch causes the LEDs to illuminate, causing the range-finding feature to become active. Opening the switch turns the LEDs off, and the device then functions as an ordinary pair of eyeglasses or sunglasses. The switch is preferably located towards the rear of the eyeglass frame, near the point at which the eyeglass is supported by the ear. But the location of the switch can be varied, within the scope of the invention.

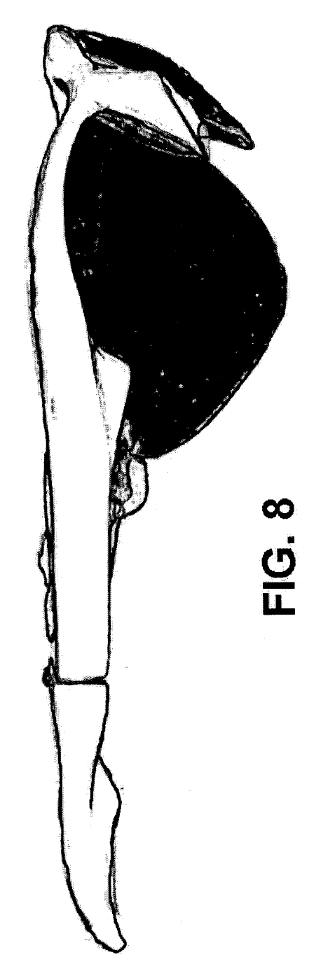

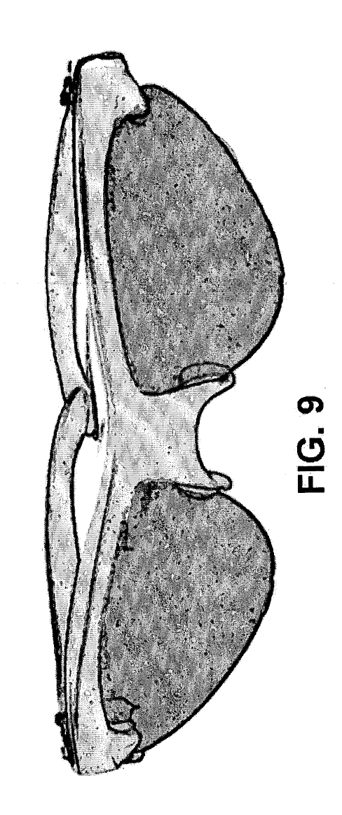

FIGS. 8 and 9 provide perspective views of the eyeglasses of the present invention. In the embodiment shown, the eyeglasses are sunglasses. The eyeglasses are similar in appearance to ordinary sunglasses, except that the frame is made sufficiently thick to house the components shown in FIGS. 6 and 7. Note also that in the preferred embodiment, the battery is housed in the bridge portion of the eyeglass frame, and thus the bridge portion must be made large enough to perform this function, as is shown in FIGS. 8 and 9. The battery required to operate the LEDs need not be heavy, however; a simple battery, such as those used in electronic watches, will suffice.

The invention is not limited to use with sunglasses. It could be incorporated into prescription eyeglasses that either include or omit a sun-blocking characteristic. The invention could also be used with binoculars or opera glasses, or many other handheld devices having a viewing lens. If used with sunglasses, the sunglass elements can have virtually any color or tint. The principle of operation would be the same for all of these alternatives.

The range-finding device of the present invention has many applications. It is useful for participants in sports, such as golf, where a player wishes to drive a ball across a long distance, and desires to know the distance to a particular landmark. It can be used by hunters to determine their distance from a tree or cliff, or from their prey. The invention can also be used by carpenters, drafters, engineers, and surveyors, for providing a quick measurement of distances to various objects at a job site. In all of these cases, the invention provides an accurate measurement of distance without the need to perform any manual operation. As long as the user can focus on a distant object, the user can immediately obtain a reading of distance, while using his or her hands for other tasks.

The holographic slide used in the present invention can be made to produce its image in virtually any desired color. It is also possible to form the displayed image in multiple colors. The slide needs only a light source to reconstruct the image. The preferred light source is an LED, but an ordinary light bulb could be used, and it is even possible to channel ambient light, through optical means, to illuminate the slide.

The positions of the focusing lenses used in the present invention can be adjusted so as to compensate for the fact that the distance between the user's two eyes will vary from one user to another. Once the adjustment has been made, it should normally be unnecessary to make any further adjustment of this kind.

It is also possible to achieve a similar result without a hologram lens, but using only the surface reflection of a concave lens that has its radius equal to the focal distance required to view the image clearly at a distance. In this alternative, the image from the backlit slide would be projected onto the surface of the concave lens, at an angle of incidence required for viewing by the user.

The invention can therefore be modified in many ways. The exact shape of the eyeglass frame can be varied, as long as it can accommodate the components necessary to practice the invention. The form of the scale and pointer can be changed, as explained above. The invention can be incorporated into many kinds of optical devices, and is not limited to eyeglasses or sunglasses. These and other similar modifications, which will be apparent to those skilled in the art, should be considered within the spirit and scope of the following claims.

What is claimed is:

1. A rangefinder device, comprising:
a) a pair of eyeglasses having a frame and a pair of eyeglass lenses,
b) first and second films held by said frame, one of said first and second films defining a distance-measurement scale, and another of said first and second films defining a pointer, and
c) means for illuminating said first and second films so as to produce images derived from said first and second films and observable by left and right eyes of a user, wherein, when said images are superimposed, said images together form an image which indicates a distance.

2. The rangefinder device of claim 1, further comprising reflective lenses disposed adjacent the eyeglass lenses, the reflective lenses being positioned to direct images from said films into said left and right eyes of a user.

3. The rangefinder device of claim 1, wherein the illuminating means comprises a light-emitting diode.

4. The rangefinder device of claim 1, wherein the illuminating means is powered by a battery located within said frame.

5. The rangefinder device of claim 1, wherein the frame supports a switch which is connected to activate and deactivate the illuminating means.

6. A rangefinder comprising:
a) a frame,
b) first and second slides held by the frame,
c) the first slide containing a first image which defines a distance-measurement scale,
d) the second slide containing a second image which defines a pointer,
e) means for projecting the first and second images separately into spaced-apart locations such that the images can be viewed, in superposition, in a binocular manner.

7. The rangefinder of claim 6, wherein the projecting means includes a pair of reflective lenses positioned to direct light from said slides into said locations.

8. The rangefinder of claim 6, wherein the projecting means includes a light-emitting diode, mounted on the frame, the light-emitting diode being powered by a battery located within the frame.

9. The rangefinder of claim 8, wherein the frame supports a switch which is connected to activate and deactivate the light-emitting diode.

10. A rangefinder comprising:
a) a frame, and
b) means, connected to the frame, for separately projecting first and second images into spaced-apart locations such that the first and second images can be viewed in superposition in a binocular manner,
wherein the first image includes an image of a distance-measurement scale and wherein the second image includes a pointer.

11. The rangefinder of claim 10, wherein the projecting means includes a holographic slide, means for illuminating the slide, and lenses positioned to direct light passing through the slide into said locations. being powered by a battery located within the frame.

12. The rangefinder of claim 11, wherein the illuminating means is controlled by a switch, such that the rangefinder operates to provide distance-measurement information only when the switch is activated.

13. A rangefinder device, comprising:
a) a pair of eyeglasses including a frame, the eyeglasses defining a left side and a right side,
b) means mounted on said frame for projecting distinct images onto the left side and the right side of the eyeglasses, wherein one of said images comprises a distance-measurement scale and another of said images comprises a pointer, and
c) means, mounted on the frame, for activating and deactivating the projecting means.

14. The rangefinder device of claim 13, wherein the projecting means includes a pair of image-bearing slides, a source of light positioned to illuminate the slides, and a lens for forming a virtual image based on content of the slides.

15. The rangefinder device of claim 14, wherein the activating and deactivating means comprises a switch which controls the source of light.

16. A method of determining distance to an object, comprising the steps of observing the object through a pair of lenses while separately projecting an image of a distance-measurement scale and an image of a pointer through said lenses, and reading a position of the pointer relative to the scale so as to obtain a reading of distance.

17. The method of claim 16, wherein the lenses are part of a pair of eyeglasses, and wherein the observing step is preceded by the step of donning the eyeglasses, wherein the observing and reading steps are performed in a hands-free manner.

18. The method of claim 17, wherein the image is projected with a source of light that is controlled by a switch attached to said pair of eyeglasses, and wherein the observing step is preceded by the step of engaging the switch so as to activate the source of light.

19. The method of claim 18, further comprising the step of disengaging the switch so as to deactivate a range-finding function of the eyeglasses.
